(19) United States
(12) Patent Application Publication
(10) Pub. No.: US 2004/0148066 A1
(43) Pub. Date: Jul. 29, 2004

(54) Method of managing a man/machine interface in a cartographic system that is at least partially located on-board an aircraft

(76) Inventor: Erick Coppolino, Medard En Jalles (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/479,612

(22) PCT Filed: May 28, 2002
(86) PCT No.: PCT/FR02/01793

(30) Foreign Application Priority Data
Jun. 19, 2001 (FR) 01 08039

(51) Int. Cl. G06F 17/00

(52) U.S. Cl. 701/3; 701/14

(57) ABSTRACT

The invention relates to the field of methods for managing a man-machine interface in an at least partially airborne mapping system.

It is a method for managing a man-machine interface, which interface associates a designator and an aircraft screen and effects the link between a user of the designator and a mapping system comprising information structured as a tree on several levels (N0, N-1, N-2, N-3, N-4) by simultaneously displaying on the screen just part of said information, each switch from one level to another during the user's progress through the tree requiring at least one click, that is to say a press of a button of the designator, followed by a release of said button and the said method can automatically reconfigure the tree as a function of the user's mission

The invention can be applied to civil and military aircraft.

The invention relates to the field of processes for managing a man-machine interface in an at least partially airborne mapping system. The interface associates a designator and an aircraft screen. The interface effects the link between a user of the designator and the mapping system which is carried aboard the aircraft, at least in part. The mapping system comprises information structured as a tree on several levels. The management process displays simultaneously on the screen just part of the information of the tree for reasons of lack of room on the screen, the major part of the screen being occupied most of the time by a terrain map. The aim of a mapping system is to allow the pilot or the user, if the latter is distinct from the pilot, subsequently referred to generally and indiscriminately as the user, to manage the environment of the aircraft under the best possible operational conditions. The key question for the user resides more in the fact of being aware of the environment of the aircraft than in the simple fact of knowing where the aircraft is. To enable the user to be aware of the environment of the aircraft under good operational conditions, the man-machine interface must be rendered as ergonomic as possible in order to enable the user to efficiently master this environment and be able to fulfil his operational mission.

A problem specific to the operation of a mapping system is that of enabling the user to access a high number of commands enabling him to influence the display of the mapping information. This access needing to be fast, on account of the operational conditions, and logical for the user, so as to prevent the latter from getting lost in the mapping system, a structure of the information as a tree on several levels is chosen. The process for managing the corresponding man-machine interface must be efficient so as to guarantee this fast and logical access to the information for the user.

According to a prior art, there is provided a process for managing the man-machine interface which manages said interface with the help of drop-down menus of the “drag and roll” type. This type of management process guarantees fast and logical access to the information for the user. A designator is a man-machine interface tool comprising at least one submit button which the user can press and which the user can release as well as means of movement in at least two directions of a cursor on the aircraft screen. Access to the information and more precisely the user's progress through the tree and in particular the switching from one level of the tree to another level of the tree is performed in respect of the user, in this type of process, by way of a movement of the user with prolonged pressing of the user on the button throughout the duration of the movement. Under operational conditions, when the user is in the aircraft, on account of the vibrations and accelerations to which the user manipulating the designator is subjected, the user is apt to control his movement poorly, thereby possibly bringing him to an erroneous location in the tree and making him lose time in returning to the desired location in the tree.

The process of man-machine interface management according to the invention, while keeping the structure of the information as a tree on several levels, thereby enabling the interface to retain its efficiency, replaces, during the manipulation of the designator by the user, in order to switch from one level to another in the tree, the prolonged pressing by a simple click, that is to say a press of the or one of the buttons of the designator, followed by a release of said button.

According to the invention, there is provided a process for managing a man-machine interface, which interface associates a designator and an aircraft screen and effects the link between a user of the designator and a mapping system comprising information structured as a tree on several levels by simultaneously displaying on the screen just part of said information, characterized in that each switch from one level to another during the user's progress through the tree requires at least one click, that is to say a press of a button of the designator, followed by a release of said button. Thus, each switch from one level to another, during the user's progress through the tree, is controlled by the user; the risk, considerable under operational conditions, of inopportune jumping to an undesired location in the tree on account of a false movement of the user in his manipulation of the designator, is very greatly diminished.

The user's progress through the tree, which is effected by switches from one level to another level, thus enabling the user to traverse the tree, is performed through a succession of clicks. The tree comprises an origin from which several branches extend, it being possible to move along a branch level by level and to do so until a branch end, also called a leaf, is reached.

Preferably, during a downward progress of the user through the tree, that is to say in a direction away from the origin of the tree and consequently going toward a branch end, the direct switch from a given level to another level not contiguous with the given level is impossible, progress then being made stepwise, and the switch from a given level to another level contiguous with the given level requires a single click. Downward progress is then made level by level, and it is carried out click by click. The menu then drops down somewhat slowly but exhibits great security as regards the manipulations of the designator by the user.

Preferably, the process preferentially maintains the displaying of all the successive levels of the branch leading from the origin of the tree to the location of the tree at which the user is situated and the process enables the user to return to any desired level from among the levels maintained displayed in a single click on said desired level. Thus, this demarcation of the history of the downward traversal of the tree and the possible direct return to any level situated between the origin of the tree and the current location of the tree, that is to say the user's location, enables the user to make the number of clicks performed very cost-effective. The process advantageously maintains the displaying of the successive levels just of the single branch leading from the origin of the tree to the location of the tree at which the user is situated. Displaying or maintaining the display of other branches exhibits little benefit and quickly becomes greedy of room available on the aircraft screen.

The process allots, on the screen, for the displaying of the information of the tree, a space of size which is preferentially invariable in the course of the user's progress through the tree. All the boxes of said allotted space are not however filled in at each stage of the user's progress through the tree. The confined space corresponds to a maximum of boxes that can be filled in with the information of a given tree. This allocation of a confined space for the displaying of the information of the tree makes it possible to keep the majority of the room available on the aircraft screen for the displaying of the terrain map proper, in contradistinction to the prior art where the displaying of the various successive parts of the drop-down menu of “drag and roll” type gradually covers the terrain map which is displayed on the screen, this being particularly awkward, for example, when the information displayed by the process enables the user to place objects on the map displayed on the screen. However, as in the prior art, certain task windows (otherwise known as “pop-up” windows) may be displayed above the map and/or above the space allotted to the displaying of the information of the tree. Moreover, when the user stops progressing through the tree, for example when he leaves the tree, the space allotted may be reassigned, for example to another tree through which the user would subsequently progress after having left the previous one. In the allotted space, advantageously, the process can display the information only in the form of an array, preferentially one-dimensional, of several boxes of identical size, each box comprising just one designatable item of information, that is to say that can be selected by the user by way of a manipulation of the designator. The preferentially one-dimensional nature of the array renders it particularly compact and convenient for the user who views it with a single glance of the eye. The maximum number of boxes of the array preferentially remains less than or equal to twenty, even for a tree that can contain several hundred items of information.

When switching to a given level, if the number of items of information corresponding to the given level is too big to be displayed in the allotted space, then the process preferentially displays only part of said information, said part being flanked by arrows of a scrollbar, the displaying of each of the arrows requiring a box, the arrows enabling the user to make all of said information scroll between said arrows. The upward-pointing arrow enables the information to be scrolled from the top downward, whereas the downward-pointing arrow enables the information to be scrolled from the bottom upward. The presence of one or more scrollbars makes it possible to keep an allotted space of small dimension even for a complex tree some of whose branches are very long. However, the scrollbars reduce for the user the immediate readability of the displayed information of the tree. It is consequently beneficial to limit to the maximum the number of scrollbars used. To do this, an information tree structure in which the level closest to the origin of the tree comprises more information to be displayed than each of the levels furthest from the origin of the tree displaying branch ends, is particularly advantageous. The tree being preferentially of pyramidal shape, said structure in fact makes it possible to some extent to equalize the distance between the origin of the tree on the one hand and the ends of the various branches on the other hand.

In order to enable the user to more quickly understand the information displayed, each given level of a branch which comprises at least one other level further away from the origin of the tree than the given level is preferentially displayed with the aid of a specific mark distinguishing it from the levels situated at the end of a branch. Thus, the user immediately understands that a box comprising a specific mark masks more precise information situated lower down the tree and that the item of information contained in said box may again be refined by simply clicking on said box. This specific mark is, for example, a small triangle which is situated in the box and the apex of which is directed toward the portion of the space allotted where the more precise information will be displayed should said box be clicked on.

In a preferential option, the process can automatically reconfigure the tree as a function of the user's mission, said reconfiguration bringing the information particularly relevant to said mission closer to the origin of the tree. This confers great flexibility on the tree. For example, let us assume that along a given branch, one of the levels corresponds to “targets” and that the immediately lower levels are “wheeled vehicles”, “tracked vehicles”, “fixed targets” and “unidentified objects”; in this tree, it will not be possible to go from the origin of the tree to one of these categories of targets other than by passing through “targets” and, in order to access a type of wheeled armored vehicle, it will be necessary to subsequently pass through “wheeled vehicles”. In the case of a “wheeled armored vehicle” special mission, all the types of wheeled armored vehicle will for example be placed at the level just below that of “targets”, that is to say at the same level as “tracked vehicles”, “fixed targets” and “unidentified objects”; the “wheeled vehicles” box having become unnecessary can for its part be deleted. Thus, during a “wheeled armored vehicle” special mission, the user accesses the targets of wheeled armored vehicle type faster than the other target types such as, for example, the targets of tracked vehicle type, this being beneficial since the user will then more often need the targets of “wheeled armored vehicle” type than the other types of target.

Among the preferential mapping functionalities offered by the process according to the invention to the user, there is the functionality making it possible to show objects on the map displayed on the screen and the functionality of hiding objects on the map displayed on the screen.

In another preferential option, the various items of information which are each displayed in a box and which are designatable simultaneously are displayed in a manner which is at one and the same time identical for each of them and specific from the others. This information then all belongs to the same level of the tree. This information is, for example, represented in one and the same color or else in one and the same shade, for example light or dark, of a color when all the boxes are represented in the same color.

The designator associated with the screen by the process is preferably a control lever or a trackball or a touch surface. A designator of the mouse type has the drawback of not being integral with the cockpit of the aircraft; its use would therefore require specific arrangements in this regard. The keyboard arrows accompanied by the “enter” key would constitute an acceptable designator but they are not generally within hand reach of the user in the cockpit of the aircraft. Other more sophisticated designators allowing a movement on the map along three dimensions are possible, as well as designators with so-called “four dimensions” or “five dimensions” whereby, in addition to the three dimensions for the direction of movement of the aircraft, they also comprise one or two dimensions, elevation and/or azimuth, in a direction of sight such as the direction of an optical viewfinder mounted on the aircraft, for example.

The joint use in respect of the process for managing the man-machine interface according to the invention of the following three characteristics, firstly at least one click required for each switch from one level to another, secondly the possibility of going back with a single click to any point of the demarcated history of the tree, thirdly an allotted space of invariable size, enables the process according to the invention to exhibit very good ergonomics allying security as regards the user's progress through the tree with cost-effectiveness of the number of clicks necessary for said progress, while reducing the room occupied on the aircraft screen for the displaying of the information by the process according to the invention.

The invention will be better understood and other features and advantages will become apparent with the help of the following description and of the appended drawings, given by way of examples, where:

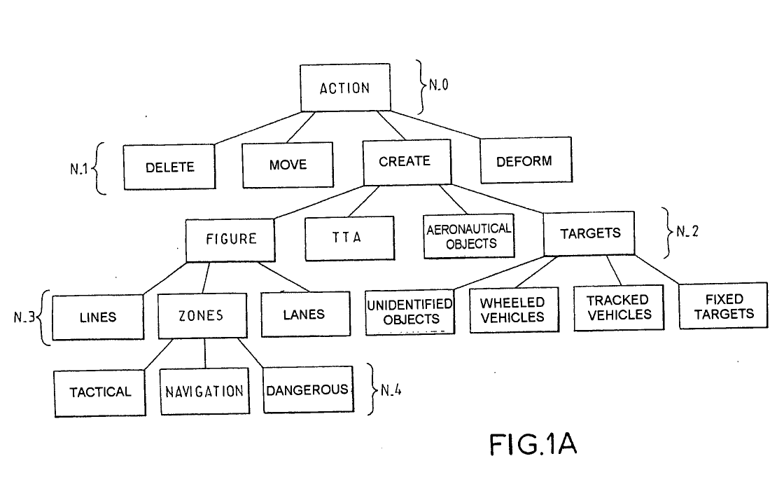

FIG. 1A diagrammatically represents a portion of an exemplary tree in a mapping system;

FIGS. 1B to 1D diagrammatically represent examples of arrays displayed by the management process according to the invention;

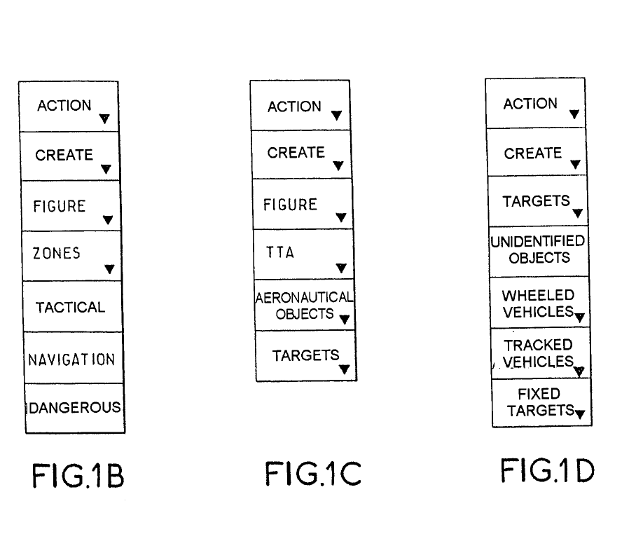

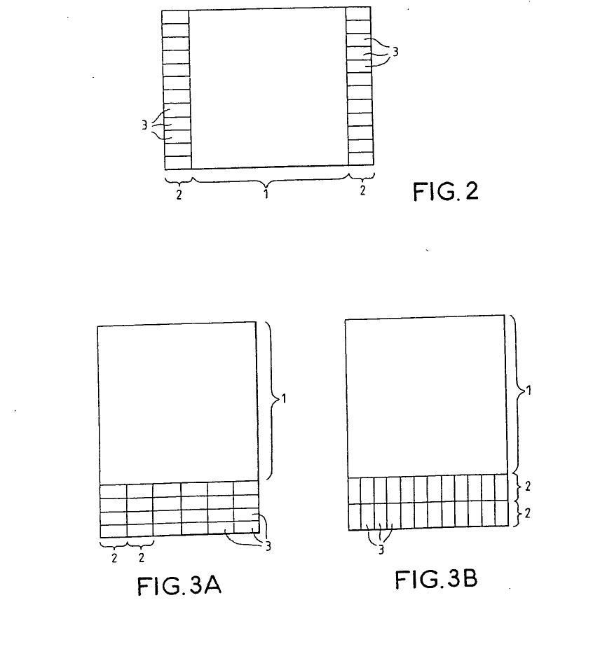

FIGS. 2, 3A and 3B represent examples of allocation of confined spaces to trees;

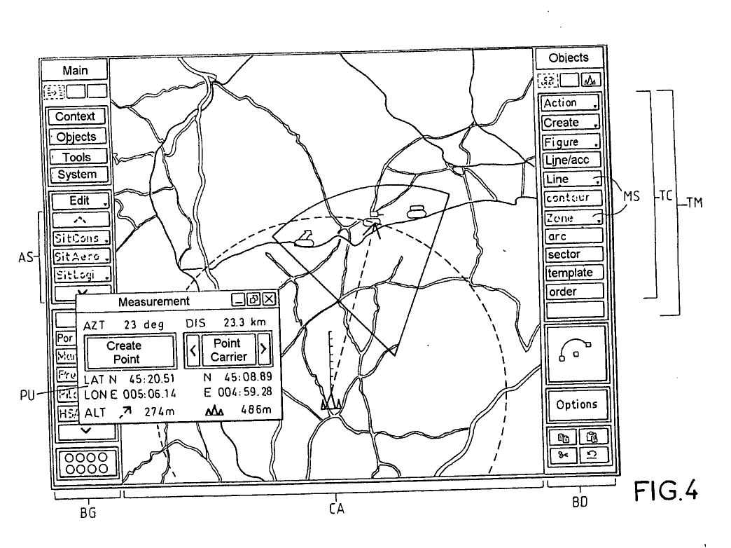

FIG. 4 represents, by way of illustration, an example of actual display on an aircraft screen.

FIG. 1A diagrammatically represents a portion of an exemplary tree in a mapping system. Each box represents an item of information of the tree, for example the item “Create”. The lines joining the boxes demarcate the structure of the tree. The “Action” box is the origin of the tree. Its level is level N0. The level closest to the origin of the tree is level N-1 and comprises the “Create”, “Delete”, “Move”, “Deform”, etc. boxes. Although the tree comprises several of them, only one level N-2 is represented, it is tied to the “Create” box, and comprises the “Figure”, “TTA”, “Targets”, “Aeronautical objects” boxes. Two levels N-3 are represented, one tied to the “Figure” box and comprising the “Zones”, “Lines”, “Lanes” boxes, the other tied to the “Targets” box and comprising the “Unidentified objects”, “Wheeled vehicles”, “Tracked vehicles”, “Fixed targets” boxes. A single level N-4 is represented, it is tied to the “Zones” box and comprises the “Tactical”, “Navigation”, “Dangerous” boxes. The closest level N-1 comprises four boxes, while the single level N-4 represented, which comprises just branch ends, comprises just three boxes. The user can, for example, place objects on the map with the aid of the “Create” box, while he can remove them from the map with the aid of the “Delete” box.

FIGS. 1B to 1D diagrammatically represent examples of arrays displayed by the management process according to the invention, after certain user clicks, when the tree is that of FIG. 1A. The boxes which are not branch ends comprise a specific mark MS differentiating them from the branch ends; for example, the “Create” box is not a branch end, while the “Delete” box is a branch end.

FIG. 1B is the array displayed on the screen after the user has clicked in succession on the “Action”, “Create”, “Figure” and “Zones” boxes. The active boxes are then the “Tactical”, “Navigation”, “Dangerous” boxes. The user therefore knows that the “Tactical”, “Navigation”, “Dangerous” boxes belong to one and the same level and are tied to the “Zones” box which is tied to the “Figure” box (of higher level, that is to say closer to the origin of the tree) which is itself tied to the “Create” box (of even higher level) which is in turn tied to the “Action” box which is the origin of the tree. To deactivate the “Tactical”, “Navigation”, “Dangerous” boxes, when the latter are active, the user must again click on the “Zone” box (of immediately higher level).

FIG. 1C is the array displayed on the screen after the user, from the screen display of FIG. 1B, has clicked just once on the “Create” box.

FIG. 1D is the array displayed on the screen after the user, from the screen display of FIG. 1C, has clicked just once on the “Targets” box.

FIGS. 2, 3A and 3B represent examples of allocation of confined spaces to trees. The axes H and L respectively represent the height axis and the width axis, these orientations being given with respect to the user who is looking at the screen.

FIG. 2 represents a display of two trees. Each tree is displayed on a vertical banner 2, the two vertical banners 2 being lateral with respect to the map 1. For example, the two banners 2 each have the same height as the map 1, but each have their width which is approximately a sixth of the width of the map 1. Each banner 2 is a one-dimensional array of boxes 3. Each banner 2 consists here of a column of boxes 3. The display of FIG. 2 advantageously represents a screen display of a military aircraft.

FIG. 3A represents a display of two trees. Each tree is displayed on three vertical banners 2, one of the trees on the three vertical banners on the left and the other tree on the three vertical banners on the right. The set of six vertical banners 2 is situated below the map 1. Each tree is represented here in a space of invariable size but with the help of a pluridimensional array comprising boxes 3 distributed over several rows and several columns; this is why FIG. 3 is not a preferential example. The display of FIG. 3B represents rather a screen display of a civil aircraft.

FIG. 3B represents a display of two trees. Each tree is displayed on a horizontal banner 2, the two horizontal banners 2 being situated below the map 1. For example, the two banners 2 each have the same width as the map 1, but each have their height which is approximately a sixth of the height of the map 1. Each banner 2 is a one-dimensional array of boxes 3. Each banner 2 here consists of a row of boxes 3. The display of FIG. 3B advantageously represents a screen display of a civil aircraft.

FIG. 4 represents, by way of illustration, an example of actual display on an aircraft screen. The map CA is surrounded by two banners BG and BD. A scrollbar AS is visible on the banner BG. Specific marks MS are visible on the two banners. A “pop-up” PU masks a part of the map CA as well as a part of the banner BG. The left banner comprises, from the top of FIG. 4 to the bottom of FIG. 4, four boxes not constituting a tree but allowing the choice of the displaying on the banner BD of one tree out of four, a tree consisting of six boxes, seven boxes partially overlapped by the “pop-up”. The banner BD displays a tree in the form of a one-dimensional array. The maximum size of the array is TM, it is equal here for example to twelve boxes. The current size of the array is TC, it is equal here for example to eleven boxes. The location at which the user is situated is the level immediately below the “Figure” box, which level comprises eight boxes that are displayed and that go from the “line/acc” box to the “order” box. The user has without doubt activated the “arc” box, since an arc of unbroken white lines is visible on the map CA, but the light and dark shades in respect of the activated and deactivated boxes are not visible in FIG. 4. In FIG. 4, in addition to the specific marks MS in the form of small triangles, the information contained in the branch ends begins with a lowercase, such as for example “arc”, while the information contained in the other boxes begins with an uppercase, such as for example “Zones”. This can be used, either as another means, or as an additional means (as in FIG. 4), of distinguishing the boxes corresponding to branch ends from the other boxes.

1. A process for managing a man-machine interface, which interface associates a designator and an aircraft screen and effects the link between a user of the designator and a mapping system comprising information structured as a tree on several levels (N0, N-1, N-2, N-3, N-4) by simultaneously displaying on the screen just part of said information, each switch from one level to another during the user's progress through the tree requires at least one click, that is to say a press of a button of the designator, followed by a release of said button, characterized in that the process can automatically reconfigure the tree as a function of the user's mission, said reconfiguration bringing the information particularly relevant to said mission closer to the origin (N0) of the tree.

2. The process as claimed in claim 1, characterized in that, during the user's progress through the tree taking him away from the origin (N0) of the tree, the direct switch from a given level to another level not contiguous with the given level is impossible and the switch from a given level to another level contiguous with the given level requires a single click.

3. The process as claimed in any one of the preceding claims, characterized in that the process maintains the displaying of all the successive levels of the branch leading from the origin (N0) of the tree to the location of the tree at which the user is situated and in that the process enables the user to return to any desired level from among the levels maintained displayed in a single click on said desired level.

4. The process as claimed in claim 3, characterized in that the process maintains the displaying of the successive levels of just the single branch leading from the origin (N0) of the tree to the location of the tree at which the user is situated.

5. The process as claimed in one of the preceding claims, characterized in that the process allots, on the screen, for the displaying of the information of the tree, a space (2) of size which is invariable in the course of the user's progress through the tree.

6. The process as claimed in claim 5, characterized in that, in the allotted space (2), the process can display the information only in the form of a one-dimensional array (BG, BD), of several boxes (3) of identical size, each box (3) comprising just one designatable item of information.

7. The process as claimed in claim 6, characterized in that the maximum number (TM) of boxes (3) of the array (BG, BD) remains less than or equal to twenty.

8. The process as claimed in any one of claims 5 to 7, characterized in that, when switching to a given level, if the number of items of information corresponding to the given level is too big to be displayed in the allotted space (2), then the process displays only part of said information, said part being flanked by arrows of a scrollbar (AS), the displaying of each of the arrows requiring a box (3), the arrows enabling the user to make all of said information scroll between said arrows.

9. The process as claimed in any one of the preceding claims, characterized in that the level (N-1) closest to the origin (N0) of the tree comprises more information to be displayed than each (N-4) of the levels furthest from the origin of the tree displaying branch ends.

10. The process as claimed in any one of the preceding claims, characterized in that each given level of a branch which comprises at least one other level further away from the origin (N0) of the tree than the given level is displayed with the aid of a specific mark (MS) distinguishing it from the levels (N-4) situated at the end of a branch.

11. The process as claimed in any one of the preceding claims, characterized in that the various items of information which are each displayed in a box (3) and which are designatable simultaneously are displayed in a manner which is at one and the same time identical for each of them and specific from the others.

12. The process as claimed in any one of the preceding claims, characterized in that the designator associated with the screen by the process is a control lever or a trackball or a touch surface.
